(19) United States
(12) Patent Application Publication
(10) Pub. No.: US 2014/0149427 A1
(43) Pub. Date: May 29, 2014

(54) SYSTEM AND METHOD FOR TAPESTRY INTERFACE SCORING

(71) Applicants: Brad WILDER, Los Angeles, CA (US); Bradley James BRIZENDINE, Agoura Hills, CA (US); Martin A. STEIN, Pasadena, CA (US); Andre Wilhelm RABOLD, Glendale, CA (US); Farhang M. ZARRINKELK, Woodland Hills, CA (US)

(72) Inventors: Brad WILDER, Los Angeles, CA (US); Bradley James BRIZENDINE, Agoura Hills, CA (US); Martin A. STEIN, Pasadena, CA (US); Andre Wilhelm RABOLD, Glendale, CA (US); Farhang M. ZARRINKELK, Woodland Hills, CA (US)

(73) Assignee: Nero AG

(21) Appl. No.: 13/685,594

(22) Filed: Nov. 26, 2012

(51) Int. Cl. G06F 17/30

(52) U.S. Cl. CPC G06F 17/3053
USPC 707/749; 707/748

(57) ABSTRACT

A system and methods are provided for scoring assets for display in a tapestry interface. In one embodiment, a method includes identifying assets for display in a tapestry interface presentation, wherein the tapestry interface provides a presentation for a plurality of assets having relevance based sizing, arrangement of the assets based at least in part on a grid pattern, receiving data for identified assets of the tapestry presentation, and scoring assets based on the received data to determine presentation characteristics for the assets in the tapestry interface. The method may also include updating the presentation of the tapestry interface on a device based on the presentation characteristics.

### CROSS REFERENCE TO RELATED APPLICATION

This application is related to commonly-assigned and concurrently filed U.S. patent application U.S. Pat. No. ______, entitled “System and Method for Presenting a Tapestry Interface”; U.S. patent application Ser. No. ______, entitled “System and Method for Presentation of a Tapestry Interface”; U.S. patent application Ser. No. ______, entitled “System and Method for Providing Tapestry Presentation”; U.S. patent application Ser. No. ______, entitled “System and Method for Presenting a Tapestry Interface with Location Services”; and U.S. patent application Ser. No. ______, entitled “System and Method for Presenting a Tapestry Interface with Interactive Commenting”, the disclosures of which are hereby fully incorporated by reference.

### FIELD

The present disclosure relates generally to presentation of a user interface, and more particularly to a system and methods for displaying graphical elements associated with an order and to emphasize relevance of one or more graphical elements based at least in part on display size.

### BACKGROUND

A common problem with management of digital media is difficulty in locating media. Many typical media management and browsing applications provide a list of file names or icons. These typical media management applications usually present digital media with the same visual weight or appearance. As such, one factor leading to the problem of locating media may be the presentation of typical systems for storing, browsing and/or locating media. By way of example, some media management applications display low resolution thumbnails of media. In many cases, these thumbnails look very similar. In such a system, stepping through each item while displayed in a larger format may be the only effective way to identify and locate media. However, such an endeavor takes far too long.

Another possible cause for difficulty in locating media is the use of handheld or mobile devices for browsing and/or managing media. Many user interfaces of handheld or mobile devices limit the user controls or presentation of media due to smaller display size, processing capabilities, etc. In addition, users typically have many files or particular types stored on their devices. Thus, there is a desire for a user interface that allows for selection and presentation of media that overcomes one or more of the aforementioned drawbacks.

### BRIEF SUMMARY OF THE DISCLOSURE

Disclosed and claimed herein are a system and methods for scoring assets for display in a tapestry interface. In one embodiment, the method includes identifying assets for display in a tapestry interface presentation, wherein the tapestry interface provides a presentation for a plurality of assets having relevance based sizing, arrangement of the assets based at least in part on a grid pattern, receiving data for identified assets of the tapestry presentation, and scoring assets based on the received data to determine presentation characteristics for the assets in the tapestry interface. The method also includes updating the presentation of the tapestry interface on a device based on the presentation characteristic.

Other aspects, features, and techniques of the disclosure will be apparent to one skilled in the relevant art in view of the following detailed description of the disclosure.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a user interface according to one embodiment;

FIG. 2 depicts a process for presenting a user interface by a device according to one or more embodiments;

FIG. 3 depicts a simplified block diagram is depicted of a device according to one embodiment;

FIG. 4 depicts a simplified system diagram according to one or more embodiments;

FIGS. 5A-5C depict graphical representations of tapestry grid according to one or more embodiments;

FIG. 6 depicts a process for scoring assets according to one or more embodiments;

FIG. 7 depicts a graphical representation for arranging assets for display according to one or more embodiments;

FIG. 8 depicts a process for scoring assets according to one or more embodiments; and

FIG. 9 depicts a graphical representation of updating a tapestry interface according to one or more embodiments.

### DETAILED DESCRIPTION OF THE EXEMPLARY EMBODIMENTS

### Overview and Terminology

One aspect of the present disclosure relates to displaying a user interface to present a plurality of assets, such as photos or media files. A device and methods are provided for presenting a tapestry interface including graphical elements for a plurality of assets. As used herein, assets can be anything that can be visually represented as a graphic or a text, but may primarily be directed to media files, photos, cover art (e.g., for music or movies), video previews (e.g., either static or animated key frames), clipart, maps or graphical advertisement blocks/banners. In one embodiment, assets may be scored to provide a sort order and display size indicating relevancy for the asset. In certain embodiments, the tapestry interface may be based on a chronological listing of assets, such as digital images. Based on relevancy determined for the assets, via user input, social media data and/.or filtering criteria, the presentation characteristics for displaying each asset in a tapestry interface may be determined. In addition, the tapestry interface may be displayed as a matrix having a fixed column or row range to provide a scrollable or navigable grid pattern wherein assets may be sized based on multiples of the grid elements. One advantage of the tapestry interface may be providing an interface that is updated live and in real time to aid a user in locating assets.

According to another embodiment, presentation of a tapestry interface may be based on updates to the presentation characteristics of the assets. By way of example, parameters of assets for display in a tapestry interface presentation may automatically be updated. Updates may be based on user activity of the tapestry interface, data received from a web based service associated with the assets for display, and/or the addition of assets to be displayed in the tapestry interface.

According to another embodiment, methods are provided for scoring assets for presentation in a tapestry interface. Scoring assets can include weighted scoring of received asset data. In one embodiment, scoring may be based on one or more of user interaction with an asset, frequency of usage, editing an asset date of last usage and date of last sharing. According to another embodiment, scoring may be based group activity for the tapestry including one or more of accepting and viewing of the tapestry interface when the tapestry interface is shared. Scoring may also be based on individual and aggregate scores for assets marked in a social network, and/or applying weighing factors to social network activities of network friends for shard assets.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include non-transitory mediums such as an electronic circuit, a semiconductor memory device, a read-only memory (ROM), a flash memory or other non-volatile memory, a floppy diskette, a CD-ROM, an optical disk, a hard disk, etc.

### Exemplary Embodiments

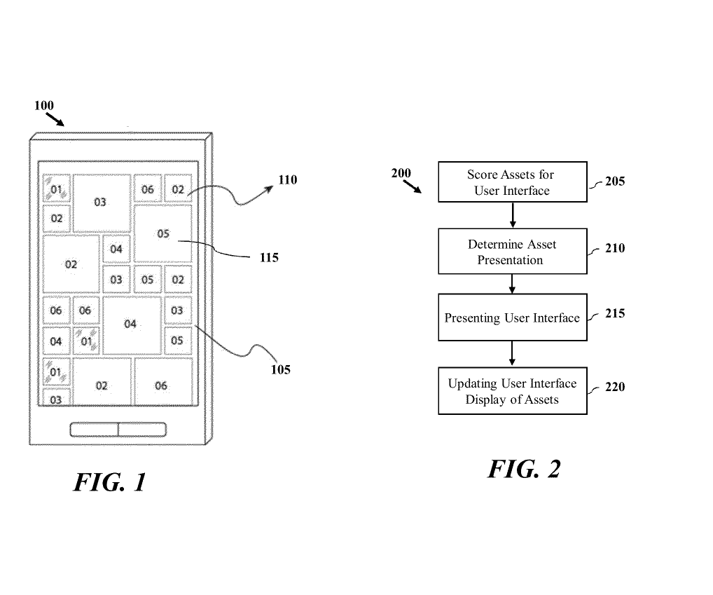

Referring now to the figures, FIG. 1 depicts a graphical representation of a user interface according to one or more embodiments. In FIG. 1, device 100 includes a plurality of graphical elements forming a tapestry interface 105. According to one embodiment, a tapestry interface is an organization of graphical tiles representing, each tile representing media or a media file, the tapestry interface based on a grid and allowing a navigable display of portions of the tapestry interface on a device. According to one embodiment, tapestry interface 105 may allow for displaying an open (e.g., unlimited) set of assets (e.g., photos) in an ordered way, emphasizing the most relevant ones by increasing their display size. Tapestry interface 105 can be immutable across multiple devices, such that layout principles and algorithms in place to ensure uniform presentation of the tapestry interface across multiple devices.

According to another embodiment, tapestry interface 105 can allow for presentation of a graphical element, or asset, based on the relevance of the asset and/or one or more criteria. In one embodiment, assets in tapestry interface 105 are arranged by two dimensions, thus providing a unique way of presenting content using not only order or location within a list or grid, but also providing a presentation to emphasize the most important or highly scored assets by adjusting their size based on relevance criteria. As a result, tapestry interface 105 can provide an interlocking grid of thumbnails of varying size. According to yet another embodiment, presentation of an asset in tapestry interface 105 may be automatically updated.

As depicted in FIG. 1, tapestry interface 105 includes a plurality of assets, such as asset 110. Assets may be one or more of files or media stored on a device or accessible by the device from a network or other location. Assets may be created from user media. According to one embodiment, tapestry interface 105 may include presentation of a single type of asset, or presentation of multiple types of assets.

According to another embodiment, presentation of assets in tapestry interface 105 may include increasing the size of one or more assets based on relevance. For example, asset 115 in FIG. 1 is depicted as having an increased display size relative to asset 110. As will be described in more detail below, asset display size may be based on a grid, wherein increased relevance is conveyed through increasing the number of grid elements associated with an asset. It should also be appreciated that relevance may be displayed based on one or more other graphical treatments in addition to or separate from display size for assets.

According to another embodiment, asset presentation may be based on one or more heuristic algorithms applied to media to automatically determine the relative importance of each media item or asset. Once importance has been determined, the presentation, such as increased size of each asset according to its calculated importance, may be determined for each asset and the organization of assets in the tapestry may be displayed. As will be discussed in more detail below, assets may be organized by chronological order first and then into a tapestry interface 105, or “size by relevance”. One advantage of the sizing is that asset presentation may be more relevant to the user. By way of example, larger photos are obviously more relevant to the user, are easier to see and therefore, the amount of time a user spends looking for and organizing his/her own media is reduced.

Display of tapestry interface 105 may include graphical tiles for image and video data. When assets relate to audio or video media, the graphical tiles may be based on artwork associated with the media title. Alternatively, or in combination, display of assets may include text or graphical elements to identify the asset in some instances.

According to one embodiment, one or more tapestry presentations may be generated and presented based on assets for display. For example, a plurality of display configurations for the assets may be determined based on scoring of the assets, user activity, selected filtering and/or device settings.

Although the description of tapestry interface 105 in FIG. 1 is with reference to a mobile device, it should be appreciated that the tapestry interface as described herein is not limited to mobile devices. For example, the tapestry interface 105 may be provided as an application for computing device, implemented in electronic devices such as imaging devices (e.g., still, video, etc.), personal media players, e-readers, display devices (e.g., televisions), etc. It should also be appreciated that although tapestry interface 105 is described above with reference to media titles, it should be appreciated that the user interface may be employed for graphical display and/or presentation of different types of elements including but not limited to account txt files, data folders, calendar appointments, contacts, etc.

Referring now to FIG. 2, a process is depicted for presenting a user interface, such as a tapestry interface, according to one or more embodiments. Process 200 may be performed by the device of FIG. 1 for displaying a tapestry interface for one or more assets. Process 200 may be initiated at block 205 by scoring assets for display in the tapestry interface, wherein the tapestry interface provides presentation of a plurality of assets based at least on in part on a grid pattern. Assets for scoring may be one or more media types and/or files stored by a device or associated with a user account, such as at least one or image data files, files stored by the device, and media accessible to the device. The assets may be based on a listing or grid arrangement of media files stored by the device (e.g., photo library, media library, application listing, etc.). By way of example, when assets for display in a tapestry relate to image data, the assets may be associated with a listing of images captured by a device. According to another embodiment, assets may relate to image data stored on a network location such as a photo sharing or social media server. For example, the assets may be arranged in chronological or alphabetical order prior to scoring and/or presentation in the tapestry interface.

In one embodiment, scoring may be based on one or more algorithms. For example, an algorithm may be employed to track different criteria about each and every asset for inclusion in a tapestry interface. Based on assets identified, the algorithm can create a system-wide relevance score, which may be variable based on the relevance and one or more user filter selections. Criteria for scoring may include, but is not limited to, social network activity (e.g., indications of a positive response, re-shares, comments, etc.), tagging, edits, views, rating, facial recognition, color cast, type of item (face, interior, landscape, etc.) and frequency of use in other creations such as albums and slideshows. In other embodiments, social network activity may include social feedback or data directed to one or more of explicit sentiments such as indication of flattery or embarrassment, and implicit sentiments that can be extracted or detected from comments associated with an asset. Note that scoring may be for one or more types of assets. Scoring can determine the asset relevance based on criteria including viewing activity of the asset by the user, and/or social media ratings for the assets (e.g., likes, forwards, etc.). Alternatively, or in addition, scoring may be based on preferences or rankings assigned by the user to the asset.

For example, a user may select a graphical element associated with the media title to determine whether to buy or rent the title. Based on the user selection, the device may display a graphical element, such as cover artwork or a graphic tile, for the media title at block 210.

At block 210, presentation characteristics of assets for display in a tapestry interface displayed based on scoring may be determined. The presentation characteristics can include presentation size and position relative to the grid is determined for each asset. Assets may be presented as graphical tiles include one or more of image data and text. According to one embodiment, determining presentation characteristics may include resizing graphical elements for display in the tiles of a tapestry presentation. By way of example, assets may require resizing, cropping or adjustment to be displayed within tiles of the tapestry interface. In one embodiment, tiles of a tapestry interface may be shaped with a square configuration. Thus, presentation characteristics for assets with a rectangular shape, such as landscape, portrait, or panoramic image data, may be resized, cropped, zoomed-in, and/or zoomed-out to be displayed within a tile of the tapestry interface. In another embodiment, the portion of an image to be displayed in a tapestry interface tile may be centered in an intelligent manner as a square thumbnail based on the subject of the image. The area of the image data for which image data is to be provided for a tile or thumbnail of the tapestry interface may be selected to reflect one or more of relevance (e.g., determined based on a user's activity, commenting, scoring, etc.), social media data, and/or attributes of the image data. For example, presentation of the tapestry interface may include digital image processing to locate one or more features of image data, such as facial recognition, to detect one or more subjects. In some embodiments, a default location for an image may be a central region of the image. In other embodiments, tiles of the tapestry interface may not be based on a square shape. For example, the tiles of the tapestry presentation may be rectangular shapes. As such, to avoid presentation of a square image in a rectangular tile, a portion of the image data may be selected such that the tile is presented based on a rectangular selection of image data of the asset. Another goal in determining presentation characteristics for an asset may be to select image data for a tile while minimizing the amount of image data cropped to present the asset. In that fashion, the tapestry interface may allow for assets with different aspect ratios to be presented in the tapestry interface. It should also be appreciated that presentation characteristics may similarly be determined for other types of assets.

The tapestry interface may be presented, such as on a device at block 215. Presentation of the tapestry interface may be based on determined sizing of each asset and arrangement of assets on the grid. The tapestry interface can be presented on a device, wherein at least a portion of the tapestry interface is displayed based on the presentation characteristics determined for each asset and arrangement of assets on the grid pattern. As will be described in more detail below, the grid pattern can include a matrix of grid spaces elements wherein one axis of the matrix is fixed to a particular range, such as a fixed number of column spaces of row spaces.

At block 220, the user interface display of assets in the tapestry presentation may be updated. Updating the display of assets may be based on user navigating or scrolling commands for the tapestry interface. Updating may also relate to updating the presentation characteristics of assets and/or limiting the assets to be included in the tapestry display. In certain embodiments, updating displayed assets may be based on a selected asset and filtering parameter, such as a filtering parameter selected from a graphical menu displayed on the device for filtering assets displayed in the tapestry presentation. Updating may also be based on filtering assets within a predetermined range (e.g., fuzziness) of a selected asset. In one embodiment, a predetermined range or fuzziness scale may be set by the user, such that the tapestry interface presents assets. For example, when the asset is an image, the predetermined range may be employed to select the asset and detection of a highly positive sentiment may be employed to present the asset with a larger presentation in comparison to other assets of the tapestry interface.

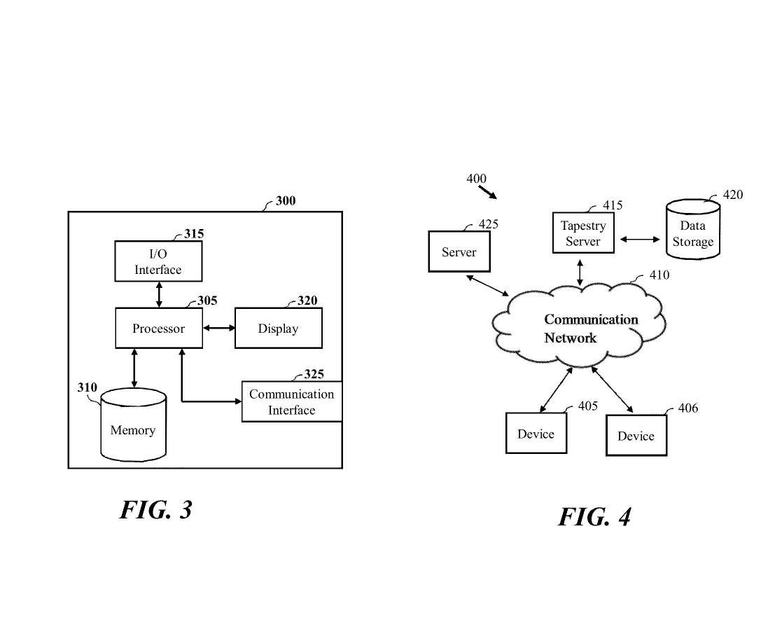

Referring now to FIG. 3, a simplified block diagram is depicted of a device according to one embodiment. In one embodiment, device 300 may be configured to provide a tapestry interface to present assets, such as media files. Device 300 may further be configured to provide a user with one or more tapestry presentations. In one embodiment, device 300 may relate to a display device, such as a television display for viewing media. It may also be appreciated that device 300 may relate to one or more devices configured to provide data to a display device such as, a set-top box, gaming console, media player (e.g., DVD, Blu-Ray™, audio player, etc.), network based communication module, etc. In a further embodiment, device 300 may relate to portable electronic devices including media players, personal communication devices, etc. Device 300 and processor 305 may be configured to employ one or more of the processes described herein to present a tapestry interface.

As shown in FIG. 3, device 300 includes processor 305, memory 310, input/output (I/O) interface 315, display 320 and network communication interface 325. Processor 305 may be configured to control operation of device 300 based on one or more computer executable instructions stored in memory 310. Memory 310 may relate to one of RAM and ROM memories and may be configured to store one or more media files, content, and computer executable instructions for operation of device 300.

I/O interface 315 may include one or more buttons for user input, such as a numerical keypad, volume control, channel control, menu controls, pointing device, track ball, mode selection buttons, and playback functionality (e.g., play, stop, pause, forward, reverse, slow motion, etc). Buttons of I/O interface 315 may include hard and soft buttons, wherein functionality of the soft buttons may be based on one or more applications running on device 300. I/O interface 315 may be employed for one or more user commands, such as scrolling or selection of a graphical element. I/O interface 315 may additionally be configured to decode one or more remote control commands for navigating a user interface. In another embodiment, device 300 may include one or more optical drives, not shown in FIG. 3, which may be configured to detect and decode one or more media files stored on a disc (e.g., CD, DVD™, Blu-Ray™, etc.). Display 320 may be employed to display a user interface, including a tapestry interface. In certain embodiments, display 320 may relate to a touch screen display configured to detect one or more user selections of the display.

Communication interface 325 may be configured to allow for network based communications including but not limited to LAN, WAN, Wi-Fi, etc. In certain embodiments, communication interface 325 may be configured to allow for one or more devices to communicate with device 300 via wired or wireless communication. Communication interface 225 may additionally include one or more ports for receiving data, including ports for removable memory.

Referring now to FIG. 4, a simplified system diagram is shown according to one or more embodiments. According to one embodiment, a tapestry interface may be generated and presented to a user by one or more applications running on a user device. According to another embodiment, the tapestry interface may be presented as a network service.

System 400 may be employed for one or more of presentation, sharing, and generating tapestry interfaces. According to one embodiment, device 405 may be a user device including one or more applications for generating a tapestry interface based on assets stored by the device. According to another embodiment, device 405 may present a tapestry interface based on data received via communication network 410. Device 405 may be configured for network communication via communication network 410 with server 415. Server 415 may be configured to receive and provide data for presenting and generating a tapestry interface for one or more devices, including device 405 and device 406. Asset and tapestry information may be stored by data storage unit 420.

In yet another embodiment, presentation of the tapestry interface may be based on data received from one or more servers, such as data provided by one or more social networking services via application programming interfaces. According to one embodiment, device 405 may be configured to receive data from one or more servers for scoring assets. For example, server 425 may relate to a server of a social networking service configured to provide data associated with view of assets, positive feedback to assets, and comments related to assets of the user of device 405. Accordingly, such information may be provided to device 405 via communication network 410 and/or server 415 to allow for assets to be scored.

Communication network 410 may allow for one or more of wired and wireless communication and for network based communications including, but not limited to, LAN, WAN, WI-FI, etc. Devices 405 and 406 of FIG. 4 may be configured to connect to server 415 via communication network 410, which may include wired and/or wireless components. It may be appreciated that system 400 may include additional servers. Data storage unit 425 may relate to a database for storage of container data. It should also be appreciated that users may share tapestry interfaces via a communication network. For example, a user associated with device 405 may initiate sharing of a tapestry interface with a user of device 406 via server 415. In certain embodiments, sharing of tapestry interfaces may be via server 425, such as a server of a social networking service.

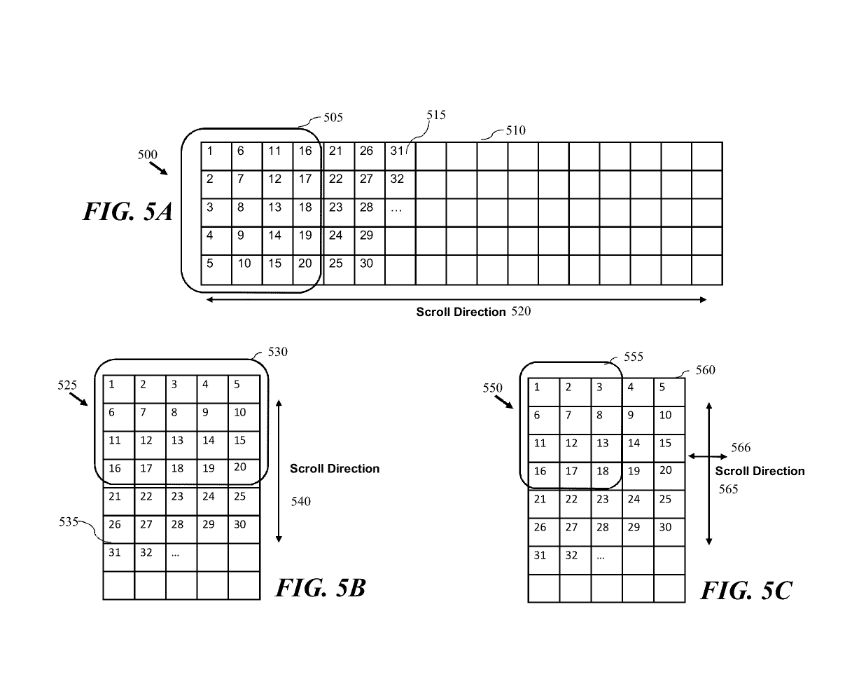

Referring now to FIGS. 5A-5C, graphical representations are shown of a tapestry grid. A tapestry grid may be a configuration of one or more grid spaces or cells that an asset may be displayed in. According to one embodiment, either the number of columns or the number of rows is fixed in the tapestry interface, whereas the other direction is unbound. By way of example, a fixed number of five columns may be employed, however it should be appreciated that any other number of columns would work the same way and still follow the exact same rules. In addition, the tapestry interface could hold any virtually an unlimited number of assets, being 1, 10, 100, 100,000 or more. However, the display of assets will generally be limited memory capabilities, and display size.

In FIG. 5A, an illustration of a tapestry grid arrangement 500 using a fixed set of five rows and an open number of columns is depicted. The actual number of columns may be determined by the number of assets and their position and size within the tapestry. According to one or more embodiments, the entire tapestry grid may not, and in many instances will not, be visible on a display window or display portion of the user interface. Element 505 relates to a portion of the display window or user interface window relative to tapestry grid 510 for which elements of the grid may be displayed. Each grid element or grid space may be associated with a single asset, such as asset 515. As will be described in FIG. 7, based on scoring of assets, the asset may occupy a plurality of grid elements.

Horizontal tapestry grid 510 is laid out with a first row by row (top to bottom), then column by column (left to right). Tapestry grid 510 may be scrolled or readjusted to allow for display window 505 to display different portions of the grid as shown by scroll direction 520.

FIG. 5B depicts a graphical representation a tapestry grid arrangement 525 having a fixed set of five columns and an open number of rows. The actual number of rows is determined by the number of assets and their position and size within the tapestry. Element 530 relates to a portion of the display window or user interface window relative to tapestry grid 535 for which elements of the grid may be displayed. Each grid element or grid space may be associated with a single asset. The vertical tapestry arrangement is laid out first column by column (left to right), then row by row (top to bottom). Tapestry grid arrangement 525 may be scrolled or readjusted to allow for display window 530 to display different portions of the grid as shown by scroll direction 540.

FIG. 5C depicts a graphical representation a tapestry grid arrangement 550 having a fixed set of five columns and an open number of rows, wherein scrolling may be performed relative to two directions, as shown by 565 and 566. The actual number of rows is determined by the number of assets and their position and size within the tapestry. Element 555 relates to a portion of the display window or user interface window relative to tapestry grid 560 for which elements of the grid may be displayed. Each grid element or grid space may be associated with a single asset. The vertical tapestry arrangement is laid out first column by column (left to right), then row by row (top to bottom). Tapestry grid arrangement 550 may be scrolled or readjusted to allow for display window 550 to display different portions of the grid as shown by scroll directions 565 and 566.

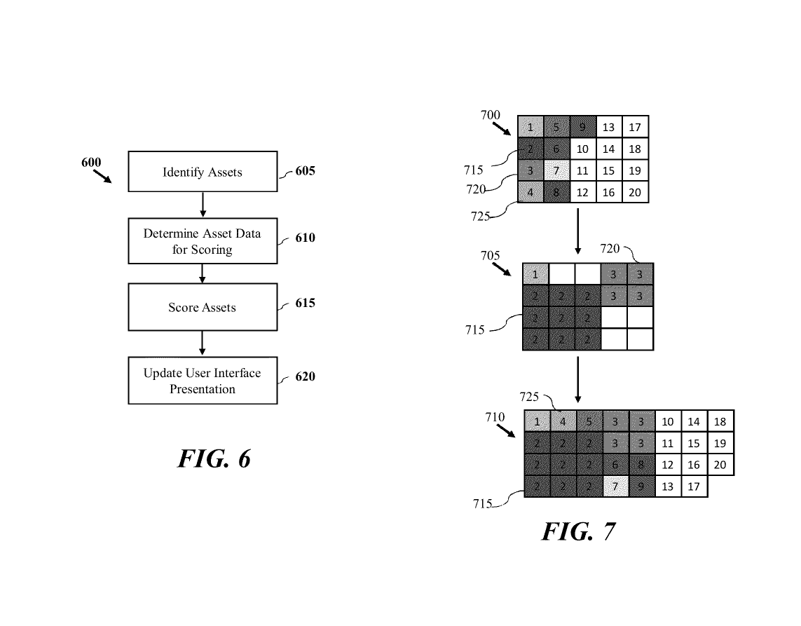

Referring now to FIG. 6, a process is shown for scoring assets. Process 600 may be performed by the device of FIG. 1 for displaying a tapestry interface including one or more assets. Process 600 may also be performed, at least in part by a server, (e.g., server 415) providing tapestry interface to a user device or other devices. Process 600 may be initiated at block 605 by identifying assets. Assets may be identified based on the type of media for display by a device, the type and/or files stored by a device, media accessible to the device, etc. At block 610, asset data for scoring can be determined. In one embodiment, asset data may be based on user activity related to an asset, such as the number of views, number of times shared, etc. According to another embodiment, asset data for scoring may be received from a server, such as a social networking server or web service tracking asset views, feedback and sharing. At block 615, assets for display in the tapestry interface can be scored. In one embodiment, scoring at block 615 may be based on one or more algorithms. For example, an algorithm may be employed to track different criteria about each and every asset for inclusion in a tapestry interface. Based on assets identified, the algorithm can create a system-wide relevance score, which may be variable based on the relevance and one or more user filter selections. Criteria for scoring may include, but is not limited to, social network activity (e.g., indications of a positive response, re-shares, comments, etc.), tagging, edits, views, rating, facial recognition, color cast, type of item (face, interior, landscape, etc.) and frequency of use in other creations such as albums and slideshows. In other embodiments, social network activity may include social feedback or data directed to one or more of explicit sentiments such as indication of flattery or embarrassment, and implicit sentiments that can be extracted or detected from comments associated with an asset. Note that scoring may be one or more types of assets.

The user interface may be updated at block 620, wherein one or more of a position, display size, display qualities and position related to a grid of the tapestry interface may be updated. The presentation characteristics can include presentation size and position relative to the grid is determined for each asset. According to one embodiment, the size of each element depends on its score by calculating the median and standard deviation of all the elements of the tapestry. According to one embodiment, weighted scoring of assets may be normalized to provide a more meaningful presentation of assets. For example, weighted scores may be normalized to a particular number of display configurations for assets, such that relevance is provided in assets occupying larger numbers of grid elements in the tapestry, while the majority of assets are displayed in a single or particular number of cells.

In one embodiment, scores can be quantitative, based on sheer count of factors, such as number of comments, or qualitative, involving for example the semantic of the comments, by extracting the sentiment expressed. According to another embodiment, progressive aging of events can affect asset scores negatively.

Referring now to FIG. 7, a graphical representation is shown of arranging assets for display of a tapestry interface based on a grid arrangement according to one or more embodiments. Tapestries are collections of images (pictures, key-frames of videos, cover artworks of music albums, etc.) owned and assembled by users of the system for a variety of purposes. In order to help users locate what they are looking for quickly, the system displays images with a set of predefined sizes, in order to bring the most relevant images to the attention of the user by making them larger, and conversely, the least relevant ones smaller. There are a number of relevance criteria in the system to allow users and viewers to see the tapestry from different perspectives.

According to one embodiment, sizes of images in tapestries are chosen among a limited set of predefined values. The area that each asset (e.g., image, display element) occupies in the tapestry, or number of grid elements, is directly related to its relevancy score. The relevancy score of each image may be affected by various factors. According to one embodiment, there are several relevancy scores that users and viewers can chose from. For example various relevancy criteria for sorting and/or selecting assets can be combined or used separately. As a result, relevancy scores are applicable within the context of a given tapestry.

In FIG. 7, layout 700 is depicted for a horizontal tapestry having four rows and twenty assets resulting in a total of 5 rows. In layout 700, each asset is associated with one grid location. The sort order of the tapestry interface assets may be based on time the asset was created, but can also be associated with any other linear or non-linear range of numbers such as a geographic distance to a specific location. The Tapestry sort order and the size/relevance criteria if changeable by user preferences or can depend on the current context.

Typically assets are either square or rectangular in size, spanning 1, 2, 3 or more cells in height or width. However, the size of the asset can be updated based on a relevance criteria, such as how often the asset has been viewed (activity on the asset), how many friends have liked in a social network (social relevance), random numbers, a rating, etc. The actual size of an asset is relative to the relevance value with more “relevant” assets being larger.

Applying various relevance criteria, the sizes of the individual assets can differ. For example, in layout 705 asset 715 is sized at 3×3 grid elements and asset 720 at 2×2 grid elements. The algorithm for determining layout of the tapestry interface will traverse field by field (first top to bottom then left to right). The first step is to place the assets to the next empty space in the grid. Asset 715 blocks columns 1-3, the asset 720 would be placed in column 4 and 5 of layout 705. As shown in layout 710, the algorithm will try to fill up the gaps by reordering assets that have not been resized, such as asset 725 placed into an empty grid space. Due to the resized assets, the number of columns increases dynamically. The final layout of the tapestry interface could be arranged similar to layout 715, wherein assets can be assigned a plurality of grid elements. According to one embodiment, when filling in gaps that occur due to different sized assets (as in layout 705), advertisement banners and/or elements may be inserted into one or more grid units of the tapestry interface.

The tapestry interface may be updated to provide a live and real-time presentation based on the addition of new assets and/or changes in properties of the assets which affect the position, (e.g., sort order) or size (e.g., relevance) with the tapestry interface. Besides an automated sorting and sizing based on relevance, a the tapestry interface can also be fully or partly user-configurable meaning that an actual user (viewer) can rearrange and resize assets with the other assets floating around accordingly following the tapestry layout algorithm.

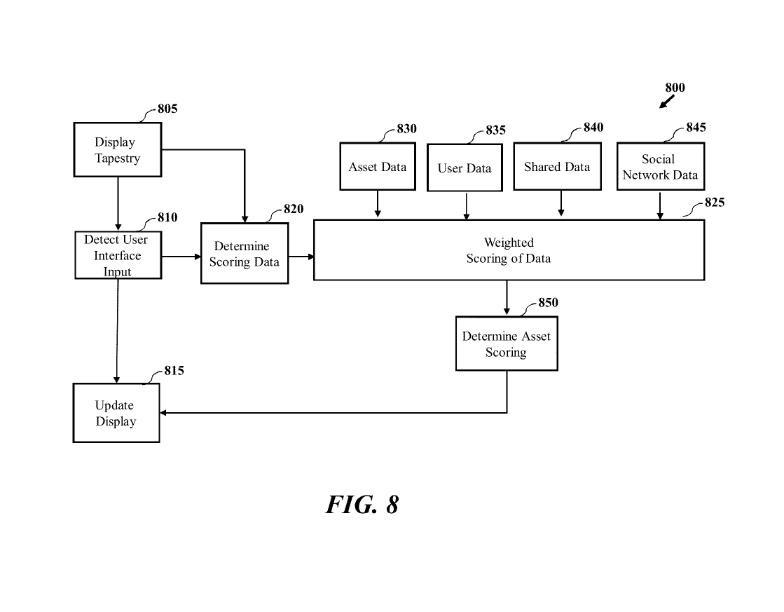

Referring now to FIG. 8, a process is shown for scoring assets according to one or more embodiments. Process 800 may be employed to present one or more tapestry configurations and in update display of a tapestry presentation. At block 805, a tapestry arrangement of assets may be displayed by a device. According to one embodiment, a tapestry interface may be automatically updated based on one or more criteria for scoring the assets of the tapestry interface. According to another embodiment and as will be discussed in more detail below, a tapestry interface may be updated based on one or more user selections. At block 810, a user interface input may be detected. A user interface input may be a user selection for filtering or selecting only particular assets. According to another embodiment, a user interface input may be a directional command for scrolling the tapestry grid arrangement. Accordingly, when the user interface input detected at block 810 does not affect the scoring of assets, the tapestry presentation may be updated to reflect a user scrolling command at block 815. According to another embodiment, the user interface input detected at block 810 may require scoring data.

Process 800 may determine scoring data at block 820. Scoring data may be received via a web service or server such as positive feedback or social network scoring for assets of the tapestry interface. According to another embodiment, determining scoring data may be based on user interaction, such as viewing, commenting, and sharing for assets at block 820. Process 800 may continue with weighted scoring of data at block 825 to determine asset scoring for each asset at block 850. Based on asset scoring, the tapestry interface display may be updated at block 815. In certain embodiments, determining scoring data at block 820 may be automatically performed due to user activity of the tapestry interface, data received from a web based service associated with the assets for display, and/or the addition of assets to be displayed in the tapestry interface following display of the tapestry interface at block 805. For example, relevance scoring may be automatically performed at predetermined intervals of time to provide live updates to the tapestry presentation interface. Relevance scoring may automatically be performed based on data received by an application programming interface (e.g., RESTful service) with a web based service, such as a social media service.

According to one embodiment, assets may be scored based on one or more criteria including but not limited to asset data 830, user data 835, shared data 840 and social network data 845. Asset data 830 may relate to metadata for the asset including one or more of the type, artist, subject, date created, etc. User data 835 may include one or more user habits, such as asset preferences, such as a personal score. The owner of the media assets can express his personal preferences for individual images by marking them as favorite, or ranking them.

In additional, the system keeps track of the user's interaction with the assets, such as frequency of usage (e.g. viewing of a picture in large resolution), the date of the last usage, the frequency and last date of sharing the asset, etc. By editing an asset, the owner's interest in the asset may be clearly conveyed and can heavily influence the score. Similarly, changing metadata associated with the asset would be considered a sign of interest. According to another embodiment, tagging an asset by various words, including for example, naming individuals seen in a picture or a video, or artist performing in a piece of music, would also be a factor increasing the score. The score can be applied to the elements of the tapestry within the context of the viewing of it by the owner.

Shared data 840 may include one or more tapestry interface configurations received from another device. When an asset owner shares a tapestry with friends and family, the group can influence the score of each thumbnail explicitly or implicitly. Various ways of explicitly affecting the score including defining or marking an asset as accepted, liked or as a favorite, ranking them, etc. Implicit scoring can be done through usage, such as viewing an asset in large resolution, watching a video clip, partially or totally, listening to a piece of audio in its entirety or just a portion of it, etc. Comments for the tapestry interface, and/or one or more assets of the tapestry interface can also influence the score of an asset quantitatively and qualitatively. By way of example, the number of comments can directly lead to an increased score for an asset. In addition, context and semantics derived from the comments can provide a basis for scoring relevance.

The tapestry interface may be shared with others or embedded on other sites (if allowed by the owner) which could also affect the score of an element of the tapestry. In addition to viewing the tapestry with the group score, each individual in the group can also decide to view the tapestry with her/his own personal scoring only too.

Social network data 845 may relate to data received from feedback generated on a social network site, such as positive feedback indicators.

Assets shared on online social networks can similarly be scored based on the number of markings (e.g. like or +1), as well as an internal score tracking system. These scores can be taken individually or be aggregated. Weighing factors can be applied, for example, by taking into account markings by friends heavier than ones done by anonymous individual. Also, higher influence can be attributed to the friends with more active social networking. Re-sharing with other friends or on other online social networks can also affect elements of the tapestries.

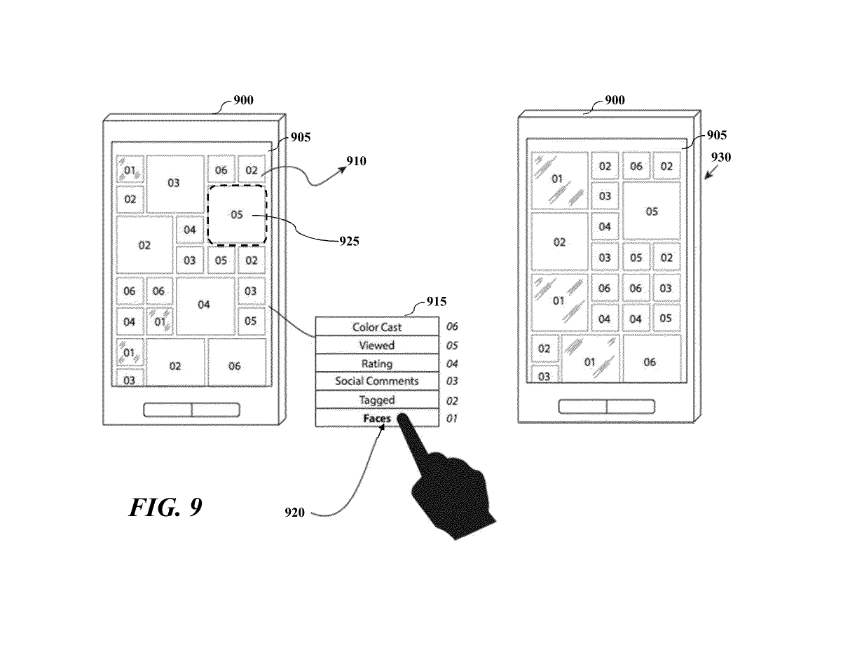

Referring now to FIG. 9, a graphical representation is shown of updating a tapestry interface according to one or more embodiments. As described herein, a tapestry interface can provide a collections of images (e.g., pictures, key-frames of videos, cover artworks of music albums, etc.) owned and assembled by users of the system for a variety of purposes. One functionality of tapestries that may be highly advantageous is that the tapestry interface can provide a quick overview about relevant assets. Combining, asset attributes such as recognized faces, geographic locations, color, scenes and relevance scores provides a new method for live filtering content in tapestries.

FIG. 9 depicts a graphical representation of updating a tapestry interface according to one or more embodiments. In one embodiment, a device 900 may be configured to display a tapestry interface 905 including a plurality of assets. Asset 910 may be associated with a single grid element of the tapestry interface. Asset 925 may relate to an asset having increased display size.

According to one embodiment, tapestry interface 905 can allows a user to select one or multiple media assets. According to another embodiment, tapestry interface 905 can allow for the tapestry interface to filter by geographic location, faces, text recognition, image color, scenes, sentiment, keyword tags, ratings, source location, relevance scores, asset owner, dates or other metadata. Device 900 may be configured to display a menu, such as menu 915. Menu 915 may be displayed as an overlay to tapestry interface 905. Based on a selection of the menu 915, such as menu listing 920, the tapestry interface presentation may be updated as shown by tapestry arrangement 930. In certain embodiments, filtering may be based on a user touch command to the tapestry interface. As shown in FIG. 9, selection of an asset on display, such as asset 925 may lead to a graphical display associated with the selection.

Menu 915 includes one or more graphical elements, or listings, for filtering assets of the tapestry interface. According to one embodiment, the tapestry interface may include one or more filters. The filters may be Boolean filters such that, each filter is either on or off during presentation of the tapestry interface. In addition, filters can be combined based on “And” or “OR” connections. One advantage of the filters for the tapestry interface is that a measure of similarity for assets may be employed when filtering.

According to another embodiment, the tapestry interface may allow for live filtering of assets. With live filtering, a user can select an asset (e.g., displayed image) in a tapestry and apply filter criteria such as geographic location. In response, the tapestry interface will automatically reflow/update the tapestry and present only matching assets with the same geographic location. In addition, the level of fuzziness may be applied to the filter by a user through a control such as a slider. With a setting of zero or no fuzziness, only exact matches will be displayed. Increasing the fuzziness will increase the margin of error for search results, which may be useful for filtering for faces or sentiments. In addition, more fuzziness will also include items with similar meaning when filtering for sentiments and keyword tags. Further, more fuzziness will allow greater distances between geo location matches, color matches, face matches, and scene matches.

According to another embodiment, the tapestry interface may allow for multiple selection of filtering criteria for assets. Selecting multiple criteria of menu 915 can provide different results as users can filter via “OR” connections or “AND” connections. Each selected tile of menu 915 can have a symbol displayed which defines the connection type, and the tapestry interface can allow the user can to switch the connection types individually.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for scoring assets for display in a tapestry interface, the method comprising the acts of:
identifying assets for display in a tapestry interface presentation, wherein the tapestry interface provides a presentation for a plurality of assets having relevance based sizing, arrangement of the assets based at least in part on a grid pattern;
receiving data for identified assets of the tapestry presentation;
scoring assets based on the received data to determine presentation characteristics for the assets in the tapestry interface; and
updating the presentation of the tapestry interface on a device based on the presentation characteristics.

2. The method of claim 1, wherein assets are at least one of image data files, files stored by the device, and media accessible to the device.

3. The method of claim 1, wherein assets are identified based on one or more of files stored by the device and data accessible to the device.

4. The method of claim 1, wherein receiving data for identified assets includes receiving one or more of social network activity, tagging, edits, views, rating, facial expressions, type of item and frequency of use.

5. The method of claim 1, wherein scoring determines the asset relevance based on criteria including one or more of viewing activity, and social media ratings.

6. The method of claim 1, wherein scoring assets includes weighted scoring of received asset data.

7. The method of claim 1, wherein scoring is based on one or more of user interaction with an asset, frequency of usage, editing an asset date of last usage and date of last sharing.

8. The method of claim 1, wherein scoring is based group activity for the tapestry including one or more of accepting and viewing of the tapestry interface when the tapestry interface is shared.

9. The method of claim 1, wherein scoring is based on individual and aggregate scores for assets marked in a social network.

10. The method of claim 1, wherein scoring includes applying weighing factors to social network activities of network friends for shard assets.

11. A computer program product stored on non-transitory computer readable medium including computer executable code for scoring assets for display in a tapestry interface, the computer program product comprising:
computer readable code to identify assets for display in a tapestry interface presentation, wherein the tapestry interface provides a presentation for a plurality of assets having relevance based sizing, arrangement of the assets based at least in part on a grid pattern;
computer readable code to receive data for identified assets of the tapestry presentation;
computer readable code to score assets based on the received data to determine presentation characteristics for the assets in the tapestry interface; and
computer readable code to update the presentation of the tapestry interface on a device based on the presentation characteristics.

12. The computer program product of claim 11, wherein assets are at least one of image data files, files stored by the device, and media accessible to the device.

13. The computer program product of claim 11, wherein assets are identified based on one or more of files stored by the device and data accessible to the device.

14. The computer program product of claim 11, wherein receiving data for identified assets includes receiving one or more of social network activity, tagging, edits, views, rating, facial expressions, type of item and frequency of use.

15. The computer program product of claim 11, wherein scoring determines the asset relevance based on criteria including one or more of viewing activity, and social media ratings.

16. The computer program product of claim 11, wherein scoring assets includes weighted scoring of received asset data.

17. The computer program product of claim 11, wherein scoring is based on one or more of user interaction with an asset, frequency of usage, editing an asset date of last usage and date of last sharing.

18. The computer program product of claim 11, wherein scoring is based group activity for the tapestry including one or more of accepting and viewing of the tapestry interface when the tapestry interface is shared.

19. The computer program product of claim 11, wherein scoring is based on individual and aggregate scores for assets marked in a social network.

20. The computer program product of claim 11, wherein scoring includes applying weighing factors to social network activities of network friends for shard assets.

21. A device, comprising:
a display;
a memory; and
a processor coupled to the display, and memory, the processor configured to:
identify assets for display in a tapestry interface presentation, wherein the tapestry interface provides a presentation for a plurality of assets having relevance based sizing, arrangement of the assets based at least in part on a grid pattern;
receive data for identified assets of the tapestry presentation;
score assets based on the received data to determine presentation characteristics for the assets in the tapestry interface; and
update the presentation of the tapestry interface on a device based on the presentation characteristics.
